(19) United States
(12) Patent Application Publication
(10) Pub. No.: US 2024/0034956 A1
(43) Pub. Date: Feb. 1, 2024

(54) CANDLE INCLUDING HEMP OIL

(71) Applicant: FARMDALE, LLC, North Hollywood, CA (US)

(72) Inventor: Roman Kardonskiy, Glendale, CA (US)

(21) Appl. No.: 18/227,893

(22) Filed: Jul. 28, 2023

Related U.S. Application Data
(60) Provisional application No. 63/393,369, filed on Jul. 29, 2022.

(51) Int. Cl. C11C 5/00

(52) U.S. Cl. CPC C11C 5/002; C11C 5/008

(57) ABSTRACT

A method of making a candle, including placing wax in a heat-resistant container; placing the heat-resistant container in the pot that includes water, wherein the heat-resistant container is smaller than a pot that includes water; heating the water in the pot until the small chunks, shavings, layers or portions melt to form a melted wax mixture; adding hemp oil, cannabidiol (CBD) oil or tetrahydrocannabinol (THC) oil to the scented melted wax mixture to create a hemp, CBD or THC melted wax mixture; placing a wick in a center of the heat-resistance container; pour the hemp, CBD or THC melted wax mixture into a candle mold container; allow the hemp, CBD or THC melted wax mixture to cool in the candle mold container to for a hemp, CBD or THC candle; and remove the candle mold container from the hemp, CBD or THC candle from the candle mold container.

### RELATED APPLICATIONS

This application claims priority to application Ser. No. 63/393,369, filed Jul. 29, 2022, entitled “Candle Including Hemp Oil,” the disclosure of which is hereby incorporated by reference.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1A illustrates a method of making a candle with hemp oil, CBD oil or THC oil according to some embodiments; and

FIG. 1B illustrates a method of making a candle with hemp oil, CBD oil or THC oil according to some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

In some embodiments, a candle may be made utilizing hemp oil. In some embodiments, a candle may be made utilizing cannabidiol (CBD) oil. In some embodiments, a candle may be made utilizing tetrahydrocannabinol (THC) oil. These candles may be utilized to provide soothing and healing properties for individuals who use and burn the candle.

In some embodiments, cannabis plants may be heated in order to extract hemp oil. In some embodiments, CBD oil may be extracted from cannabis plants. In some embodiments, oil including THC (THC Oil) may be extracted from the cannabis plants. In some embodiments, a percentage of weight of THC in the oil may be less than 0.3 percent. In some embodiments, a percentage of weight of THC in the extracted oil may be greater than 0.3 percent. In some embodiments, an extracting process for the hemp oil or the other oils may be one of the known extracting processes in the art. In some embodiments, a percentage of weight of CBD in the oil may be less than 0.3 percent. Alternatively, in some embodiments, a percentage of weight of CBD in the oil may be equal to or greater than 0.3 percent. In some embodiments, a percentage of weight of hemp in the oil may be less than 0.3 percent. Alternatively, in some embodiments, a percentage of weight of hemp in the oil may be equal to or greater than 0.3 percent.

Hemp oil may be able to help certain health issues, such as inflammation and skin conditions. The CBD in CBD oil may effectively alleviate many conditions, including anxiety, diabetes, and neurological disorders. The CBD in CBD oil may assist patient in improving acne or potentially slowing the progression of heart disease and Alzheimer's. The THC in THC oil may help alleviate problems in patients with glaucoma, insomnia, decreased appetite during chemotherapy or other difficult cancer or medical treatments.

A candle including extracted hemp oil, CBD oil, or THC oil may also provide these benefits. A candle including hemp oil, CBD oil or THC oil may be lit in a room with a patient or user and the patient or user may obtain the benefits described above. In these situations, the user or patient may not need to smoke cannabis itself in order to obtain the benefits listed immediately above. The benefits of the hemp oil, CBD oil or THC oil may be obtained by breathing in the smoke of the candle made utilizing these oils.

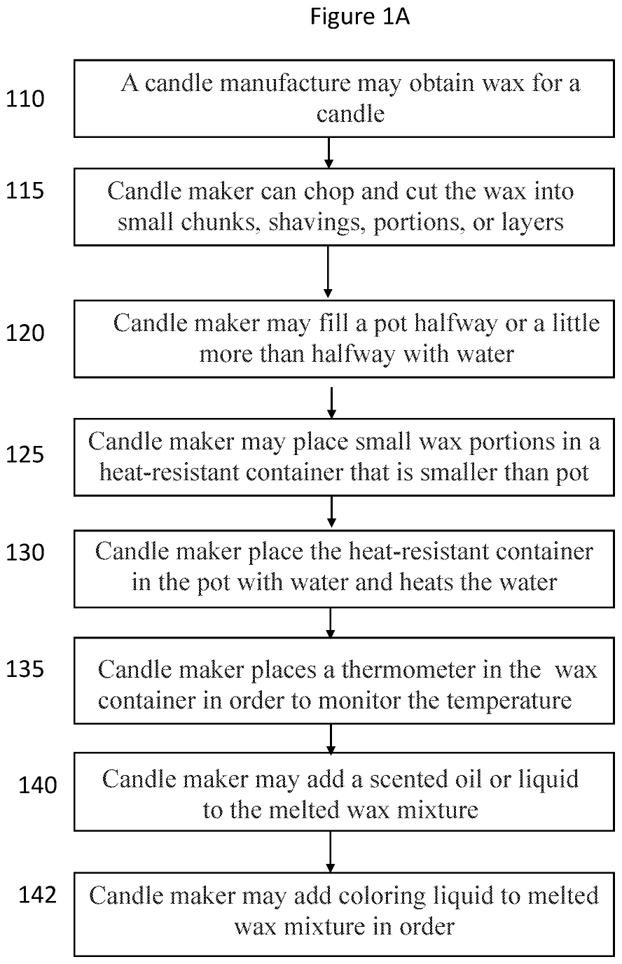

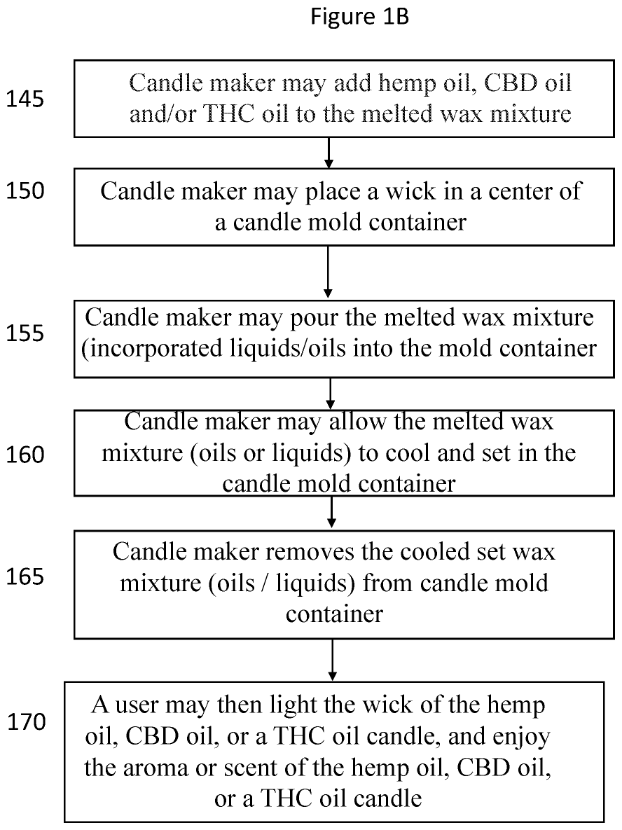

FIG. 1 illustrates a method of making a candle with hemp oil, CBD oil or THC oil according to some embodiments.

In step 110, in some embodiments, a candle manufacture may obtain wax for a candle. The wax for the candle may be paraffin wax, soy wax, or beeswax. In some embodiments, wax from old candles may be utilized for new candles. In step 115, in some embodiments, the candle maker should chop and cut the wax into small chunks, shavings, portions, or layers in order to allow the wax to melt quicker and better.

In step 120, in some embodiments, the candle maker may fill a pot halfway or a little more than halfway with water. In step 125, in some embodiments, the candle maker may place the small chunks, shavings, layers and/or portions of wax in a heat-resistant container that is smaller than the pot that includes the water. In other words, in a container that does not melt (e.g., the heat-resistant container means a container that does not melt). In step 130, in some embodiments, the candle maker shall place the heat-resistant container in the pot that includes the water. In step 130, in some embodiments, the candle maker may place the pot on the stove or over a fire in order to heat the water. As the water boils in the pot, the boiling water will melt the wax that is in the heat resistant container. In step 135, the candle maker should place a thermometer in the container including the wax in order to monitor the temperature. In some embodiments, the wax may be melted at a temperature between 115 degrees Fahrenheit to 145 degrees Fahrenheit, alternatively between 165 to 190 degrees Fahrenheit, or alternatively between 140 to 180 degrees Fahrenheit. The different temperatures may be based on which wax is being utilized in the candle (e.g., paraffin wax, soy wax or beeswax may all have different melting points). In some embodiments, the candle maker may be able to visually see when the wax portions, chunks, shavings or layers have melted. In other embodiments, the process may be started utilizing new wax or balls or large chunks of used wax.

In step 140, in some embodiments, the candle maker may add a scented oil or liquid to the melted wax mixture. In some embodiments, in step 142, the candle maker may add a coloring liquid (e.g., food coloring liquid) to the melted wax mixture in order to color the melted wax mixture. This may occur in addition to or instead of adding a scented oil or liquid to the melted wax mixture. In some embodiments, it may be important to weigh the melted wax mixture to have a weight measurement. In some embodiments, the weight of the scented oil or liquid should be less than 10 percent of the weight of the melted wax mixture. Alternatively, in some embodiments, the weight of the scented oil or liquid should be between 4 to 10 percent of the weight of the melted wax mixture.

In step 145, the candle maker may add hemp oil, CBD oil and/or THC oil to the melted wax mixture. In some embodiments, the hemp oil, CBD oil and/or the THC oil may be added to the melted wax mixture in addition to or as an alternative to the scented oil or liquid and/or coloring liquid. In some embodiments, the weight of the hemp oil, CBD oil and/or THC oil should be less than 5 percent of the weight of the melted wax mixture. In some embodiments, the weight of the hemp oil, CBD oil and/or THC oil should be less than 10 percent of the weight of the melted wax mixture. In some alternative embodiments, the weight of the hemp oil, CBD oil and/or THC oil should be between 5 to 10 percent of the weight of the melted max mixture. If any of the oils alone or in combination are greater than 10 percent of the total mixture weight, the candle may have trouble setting into a solid.

In step 150, in some embodiments, the candle maker may place a wick in a center of a candle mold container. In some embodiments, the candle mold container may be a tin, a metal tin, a mason jar, a teacup or another container that can withstand heat. In some embodiments, It may be best to have the wick in a center of the mold and a candle maker may wrap the wick that is outside of the candle around a pen or pencil that is resting on a top of the candle mold container.

In step 155, in some embodiments, the candle maker may pour the melted wax mixture and/or the other incorporated liquids or oils into the candle mold container.

In step 160, in some embodiments, the candle maker may allow the melted wax mixture and/or any oils or liquids (e.g., scented oils, food coloring, hemp oil, CBD oil, and/or THC oil) to cool and set in the candle mold container. In some embodiments, the candle mold make allow the melted wax mixture and/or any oils or liquids to cool or set (or become a solid structure) for approximately 24 hours, or alternatively may allow the melted wax mixture and/or any oils or liquids to cool and set or become a solid between 4 to 10 hours.

In step 165, in some embodiments, the candle maker may remove the cooled or set wax mixture including any oils or liquids from the candle mold container. This may form the candle. In step 170, in some embodiments, a user may then light the wick of the hemp oil, CBD oil, or a THC oil candle, and enjoy the aroma or scent of the hemp oil, CBD oil, or a THC oil candle.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device. A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A method of making a candle, comprising:
placing small chunks, shavings, layers or portions of wax in a heat-resistant container;
placing the heat-resistant container in the pot that includes water, wherein the heat-resistant container is smaller than a pot that includes water;
heating the water in the pot until the small chunks, shavings, layers or portions melt to form a melted wax mixture;
monitoring a temperature of the wax mixture in the heat-resistant container;
adding a scented oil or liquid to the melted wax mixture;
adding hemp oil, cannabidiol (CBD) oil or tetrahydrocannabinol (THC) oil to the scented melted wax mixture to create a hemp, CBD or THC melted wax mixture;
placing a wick in a center of the heat-resistance container;
pouring the hemp, CBD or THC melted wax mixture into a candle mold container;
allowing the hemp, CBD or THC melted wax mixture to cool in the candle mold container to for a hemp, CBD or THC candle; and
removing the candle mold container from the hemp, CBD or THC candle from the candle mold container.

2. The method of claim 1, further comprising:
adding a coloring liquid before adding the hemp oil, CBD oil or THC oil to the scented melted wax mixture to color the melted wax mixture.

3. The method of claim 1, wherein a percentage of weight of CBD in the CBD oil may be less than 0.3 percent, a percentage of weight of THC in the THC oil may be less than 0.3 percent, or a percentage of weight of hemp in the hemp oil may be less than 0.3 percent.

4. The method of claim 1, wherein the small chunks, shavings, layers or portions of wax may be paraffin wax, soy wax, or beeswax.

5. The method of claim 1, wherein the weight of the scented oil or liquid may be less than 10 percent of the weight of the melted wax mixture.

6. The method of claim 1, wherein the weight of the hemp oil, the CBD oil or the THC oil should be between 5 to 10 percent of the weight of the melted wax mixture.

7. The method of claim 1, wherein the hemp, CBD or THC melted wax mixture cools in the candle mold container for between 4 to 10 hours.
